(19) United States
(12) Patent Application Publication
(10) Pub. No.: US 2007/0209081 A1
(43) Pub. Date: Sep. 6, 2007

(54) Methods, systems, and computer program products for providing a client device with temporary access to a service during authentication of the client device

(76) Inventor: Robert Paul Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/365,025

(22) Filed: Mar. 1, 2006

(51) Int. Cl. H04N 7/16

(52) U.S. Cl. 726/29

(57) ABSTRACT

Methods, systems, and computer program products for providing a client device temporary access to a service during authentication of the client device are described. According to one method, client information and certification authority information are received from a client device. Further, a first authentication of the client device is performed based on the certification authority information and information identifying a trusted certification authority. In response to success of the first authentication, service access corresponding to the first authentication is provided to the client device. Further, in response to success of the first authentication, a second authentication of the client device is performed based on the client information. In response to success of the second authentication, service access corresponding to the second authentication of the client device is provided.

### TECHNICAL FIELD

The subject matter described herein relates to methods, systems, and computer program products for providing service access to a client device. More particularly, the subject matter described herein relates to methods, systems, and computer program products for providing a client device with temporary access to service during authentication of the client device.

### BACKGROUND

Wireless client devices that are mobile, such as mobile phones notebook computers, personal digital assistants (PDAs), and the like, must change wireless access points (WAPs) as they leave the area covered by one WAP and enter the area covered by another WAP. The speed with which the switch is made affects the experience of the user of the wireless device. It is desirable to quickly provide some level of service to the user when switching between WAPs.

One problem with switching between WAPs is re-authentication and re-authorization to the WAP and/or to any service the user may be using on the network. The processes of re-authenticating and re-authorizing a wireless device should be coordinated in order to prevent forcing wireless devices to re-authenticate and re-authorize each time that they switch between WAPs. Further, the switching process should be fast in order to make the process transparent to the user.

Current solutions for WAP switching use a centralized security authority to re-authenticate and re-authorize a wireless device as it enters an area covered by a new WAP. Because WAPs do not typically store authentication information for security reasons, the user must communicate with the centralized security authority to maintain service access in the area covered by the new WAP. The process of full authentication with a centralized security authority each time a user enters an area covered by a new WAP can cause discontinuity and delay in service access. Moreover, the centralized security authority can become overloaded with reauthentication requests from multiple users.

In view of the shortcomings of existing techniques for authenticating client devices, there exists a need for improved methods, systems, and computer program products for providing a client device with temporary access to a service during authentication of the client device.

### SUMMARY

According to one aspect, the subject matter described herein includes a method for providing a client device temporary access to a service during authentication of the client device. The method includes receiving client information and certification authority information from a client device. Further, the method includes performing a first authentication of the client device based on the certification authority information and information identifying a trusted certification authority. In response to success of the first authentication, service access corresponding to the first authentication is provided to the client device. Further, in response to success of the first authentication, a second authentication of the client device may be performed based on the client information. In response to success of the second authentication, service access corresponding to the second authentication of the client device may be provided.

The subject matter described herein can be implemented as a computer program product comprising computer executable instructions embodied in a computer readable medium. Exemplary computer readable media suitable for implementing the subject matter described herein include disk memory devices, chip memory devices, application specific integrated circuits, programmable logic devices, and downloadable electrical signals. In addition, a computer program product that implements the subject matter described herein may be located on a single device or computing platform. Alternatively, the subject matter described herein can be implemented on a computer program product that is distributed across multiple devices or computing platforms.

### BRIEF DESCRIPTION OF THE DRAWINGS

Exemplary embodiments of the subject matter will now be explained with reference to the accompanying drawings, of which:

FIG. 1 is a block diagram illustrating an exemplary communications network for providing a client device with temporary access to a service during authentication of the client device according to an embodiment of the subject matter disclosed herein;

FIG. 2 is a flow chart of an exemplary process for providing a client device temporary access to a service during authentication of the client device according to an embodiment of the subject matter described herein;

FIG. 3 is a flow chart of an exemplary process for providing the client device shown in FIG. 1 with temporary access to a service during authentication of the client device according to an embodiment of the subject matter described herein;

FIG. 4 is a flow chart of an exemplary process for providing a client device shown in FIG. 1 temporary access to a service during authentication of the client device according to an embodiment of the subject matter described herein; and

FIG. 5 is a message flow diagram of exemplary communication between a WAP, a client device, and a security authority server for providing the client device temporary access to a service according to an embodiment of the subject matter described herein.

### DETAILED DESCRIPTION

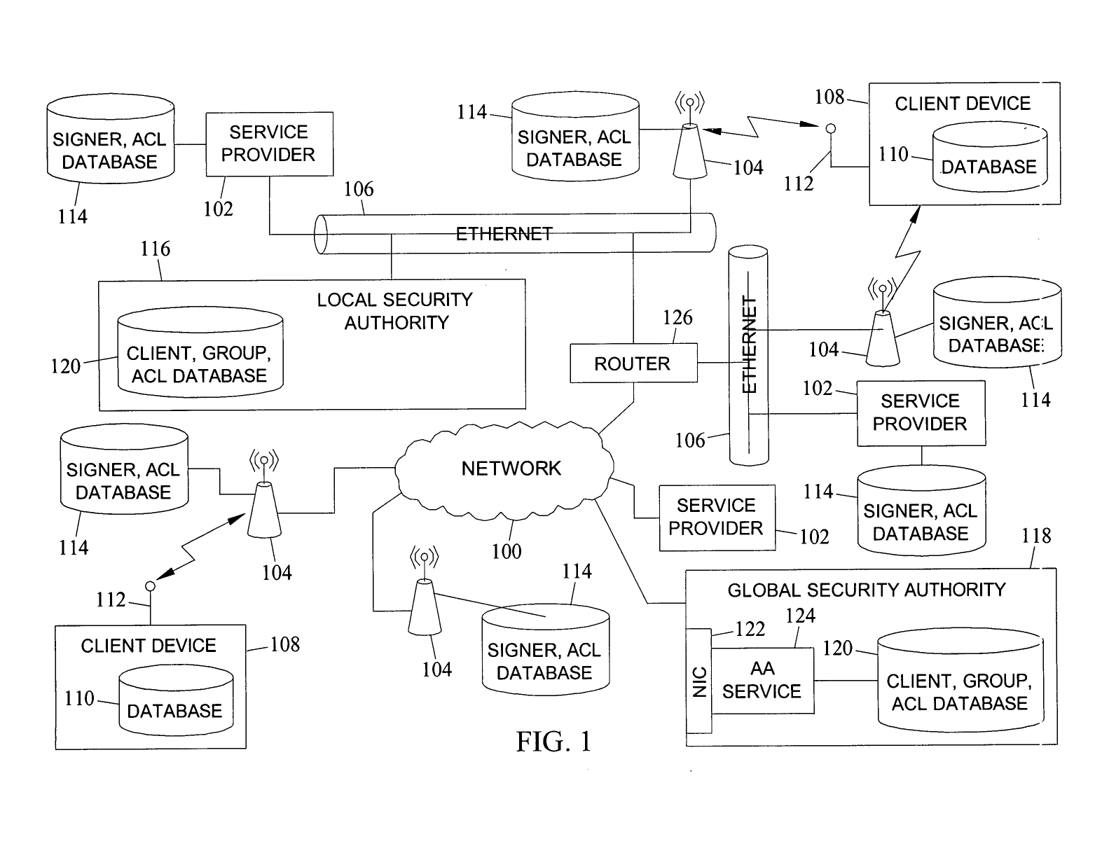

According to one aspect, a system for providing a client device with temporary access to a service during authentication of the client device may be implemented as hardware, software, and/or firmware components executing on one or more components of a communications network. FIG. 1 illustrates an example of a communications network 100 including a system for providing a client device with temporary access to a service during authentication of the client device by a security authority according to an embodiment of the subject matter described herein. Network 100 may be any suitable wireless communications network for providing wireless communications services to one or more mobile client devices, such as a mobile phone, a computer, a personal digital assistant, and the like. Exemplary wireless communications services include voice communications services and/or data communications services (e.g., e-mail, text messaging, video, and multimedia). Referring to FIG. 1, network 100 may include one or more service provider servers 102 and WAPs 104. Servers 102 and WAPs 104 may be in communication via an Ethernet link 106. WAPs 104 may provide wireless communications services to one or more client devices 108.

Client devices 108 may move between the coverage area of WAPs 104 or initiate a new connection within one of WAPs 104. When client device 108 moves to the coverage area of WAP 104 or initiates a connection within WAP 104, client device 108 may communicate information for use by the service provider operating the WAP in authenticating and authorizing the device. Client device 108 may include means for communicating a message to service provider server 102 including client information of the client device and certification authority information that identifies a certification authority. For example, client device 108 may store client information including one or more signed client certificates in a certification database 110. The client information may be any suitable information that identifies client device 108 as being a subscriber to services provided by a service provider. Further, for example, client device 108 may include an antenna 112 and one or more other suitable components for communicating the client information and certification authority information to WAP 104 with which the client device is attempting to establish communication service.

A client certificate may be a digital certificate signed by one or more certificate authorities or other trusted authority or authorities, such as a security authority granting access to the network and network resources. Different certificate signers on a client certificate may be unrelated. That is, there may be one certification authority for security on a network and one or more services available via the network may provide their own security services. Each certificate may be associated with a group that has been granted a different set of services and associated authorizations. The authorizations may overlap with one another.

Several different techniques may be used for assuring a service provider that a sent message was signed by a certification authority. Some of these techniques involve certificates, which are digitally signed statements that attest to the identify of a keyholder. One approach (available from PGP Corporation of Palo Alto, Calif.) allows anyone to vouch for anyone else's identity. If a trusted entity vouches for the authenticity of the key of another, a reader is more inclined to believe the authenticity of the key. In this approach, one person may sign another person's key as a statement that the key belongs to the owner.

Another technique utilizes formal certificate authorities to vouch for messages. In this technique, a root certification authority may issue certificates of authenticity. The certificates may be provided to entities that present credentials such as a user login identification and password, a driver's license, a passport, or other suitable items identifying the entity. Typically, the certificate authorities may be organized in hierarchies. For example, a national government or corporate entity may operate as a root certification authority, which accredits secondary certificate authorities, which accredit individual users.

Client device 108 may include means for communicating client information and certification authority information to a service provider. For example, client device 108 may communicate a message to WAP 104 including information identifying the device and certification authority information. Client device 108 may wirelessly transmit the information to WAP 104.

The system illustrated in FIG. 1 may include means for receiving client information and certification authority information from a client device. For example, WAP 104 may receive a message from client device 108 including client information and certification authority information that identifies the certification authority. Further, WAP 104 may include a signer and access control list (ACL) database 114 including identity information for identifying one or more certificate authorities. As discussed in further detail herein, temporary service access may be provided to client devices 108 providing certification authority information identified in database 114.

The system illustrated in FIG. 1 may include means for performing a first authentication of client device 108 based on the certification authority information and information identifying a trusted certification authority. Further, the system illustrated in FIG. 1 may include means for providing service access corresponding to the first authentication to client device 108 in response to success of the first authentication. For example, client device 108 may send a message to WAP 104 that contains certification authority information identifying one or more certificate authorities. The certification authority information may be a signature of a certification authority associated with the client information. Based on the received certification authority information, WAP 104 may search database 114 for matching information that identifies a trusted certification authority. If matching certification authority information is found in database 114, service access may be provided to client device 108 that communicated the matching certification authority information. The service access may be temporarily provided to client device 108 until client device 108 is authenticated with client information. Matching certification authority information may provide client device 108 with access to one or more services from one or more different service providers. Further, WAP 104 may communicate a message including certification authority information that identifies more than one service provider. Client device 108 may be provided temporary access to the several different services provided by a group of service providers based on the certification authority information identifying the multiple service providers.

Client device 108 may include means for receiving access to the service provided by the service provider based on the certification authority information. For example, WAP 104 may provide client device 108 with temporary service access based on the certification authority information. The access may be provided while device 108 is authenticated by the service provider. Device 108 may be authenticated by the service provider by using client information provided by device 108. Device 108 may receive service from the service provider by communicating via antenna 112. The access provided to client device 108 based on the certification authority information may be temporary until the client device is authenticated. The access provided by the service provider based on the certification authority information may be terminated or blocked if client device 108 is not authenticated by a service provider.

The system illustrated in FIG. 1 may include means for performing a second authentication of client device 108 based on the client information and in response to success of the first authentication. For example, WAP 104 may communicate client information received from client device 108 to a local security authority server 116 or a global security authority server 118 for authenticating device 108. Servers 116 and 118 may each include a client group, and access control list (ACL) database 120 storing information for authentication of client devices. Based on the received client information, server 116 or server 118 may search database 120 for an entry corresponding to the client information provided by WAP 104 and for authenticating client device 108 based on the entry. If client device 108 is successfully authenticated, the server that authenticated the client device may transmit a message to the WAP servicing the client device for indicating that the client device has been authenticated. If client device 108 is not successfully authenticated, the server may transmit a message to WAP 104 indicating that the client device has not been authenticated. Service access provided to client device 108 may be maintained based on whether the client device is authenticated.

The system illustrated in FIG. 1 may include means for providing service access corresponding to the second authentication of client device 108 in response to success of the second authentication. For example, server 116 or server 118 may authenticate client device 108 and communicate a message to WAP 104 to indicate that device 108 has been authenticated. WAP 104 may continue to provide the service access to device 108 on receiving information indicating that device 108 has been authenticated. In another example, server 116 or server 118 may determine that device 108 cannot be authenticated based on the client information. If device 108 cannot be authenticated, server 116 or server 118 may communicate a message to WAP 104 for indicating that device 108 cannot be authenticated. If WAP 104 receives a communication indicating that device 108 cannot be authenticated, WAP 104 may terminate the service access provided to device 108 that corresponds to the first authentication. If WAP 104 does not receive a communication indicating that device 108 has been authenticated within a specified time period, WAP 104 may terminate the service access.

Server 118 may include a network interface card (NIC) 122 and an authentication and authorization service function 124. NIC 122 may be operable to interface with network 100. Function 124 may be operable to receive messages including client information from network 100 and access data from database 120. Further, function 124 may authenticate and authorize client devices 108 in accordance with the subject matter described herein.

Client device 108 may include means for providing client device 108 with continued access to the service based on authentication using the client information. As described herein, WAP 104 may continue to provide service to device 108 if the device is authenticated. Otherwise, if device 108 is not authenticated, the service provided to the device may be terminated.

Network 100 may include one or more routers 126 and Ethernets 106 for communicating messages and/or data between the components of network 100. Further, network 100 may include any other suitable components for communicating messages and/or data.

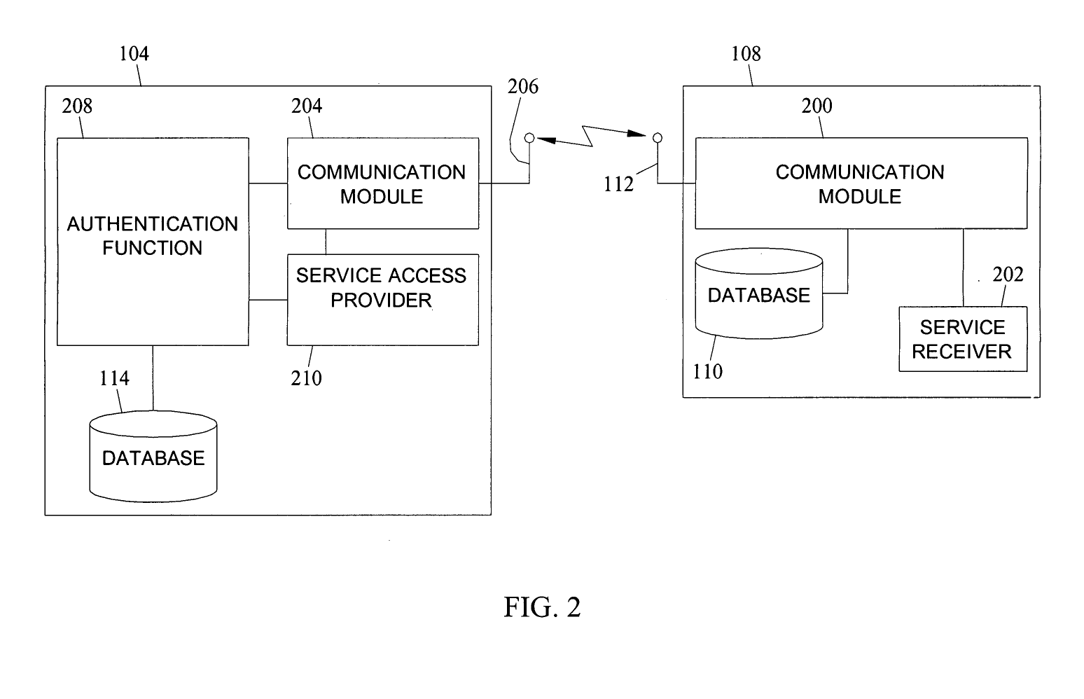

FIG. 2 is a block diagram illustrating more detail of WAP 104 and client device 108 according to an embodiment of the subject matter described herein. Referring to FIG. 2, client device 108 may include a communication module 200, a service receiver function 202, and database 110. Communication module 200 may communicate a message to WAP 104 that includes client information and certification authority information. The client information and certification authority information may be retrieved from database 110. Function 202 may be operable to receive one or more services provided by WAP 104 and coordinate the services provided by WAP 104 with the components of device 108.

WAP 104 may include a communication module 204, an antenna 206, an authentication function 208, a service access provider function 210. Communication module 204 and antenna 206 may be operable to receive client information and certification authority information from client device 108 and communicate the information to function 208. Function 208 may perform a first authentication of client device 108 based on the certification authority information and information identifying a trusted certification authority. Database 114 may store information identifying a trusted certification authority. Function 208 may search database 114 for information matching the certification authority information communicated by device 108. If matching information is found and authentication is successful, device 108 may be allowed to temporarily use a service provided by WAP 104. Function 210 may provide one or more services to device 108 based on the authentication.

WAP 104 may communicate the client information received from device 108 to local security authority server 116 or to global security authority server 118 (shown in FIG. 1) for full or second authentication device 108. Server 116 or server 118 may use the client information for authenticating device 108. If the full or second authentication is successful, communication module 204 may receive a message indicating successful authentication. In response to a successful full or second authentication, authentication function 208 may instruct service access provider function 210 of the successful authentication and grant service access to device 108 consistent with the second authentication. For example, if device 108 was granted temporary access to a full set of services provided by the network, service access provider function 210 may make the temporary access permanent. In another example, if device 108 was granted access to a limited set of services based on the initial authentication, service access provider 210 may grant client device 108 access to a full set of services provided by the network in response to the successful second authentication.

If device 108 is authenticated, function 210 may provide service access to device 108 based on the authentication. If device 108 cannot be authenticated, server 116 or server 118 may communicate a message to WAP 104 for indicating that device 108 cannot be authenticated. If WAP 104 receives a communication indicating that device 108 cannot be authenticated, function 210 may terminate the service access provided to device 108 that corresponds to the first authentication. Alternatively, if device 108 was granted temporary or limited access based on the first authentication and the second authentication is unsuccessful, device 108 may be allowed to continue the temporary or limited access for a time period configurable by the network operator. For example, it may be desirable to allow client device 108 sufficient time to reauthenticate if the user of client device made an error in communicating the authentication information to WAP 104.

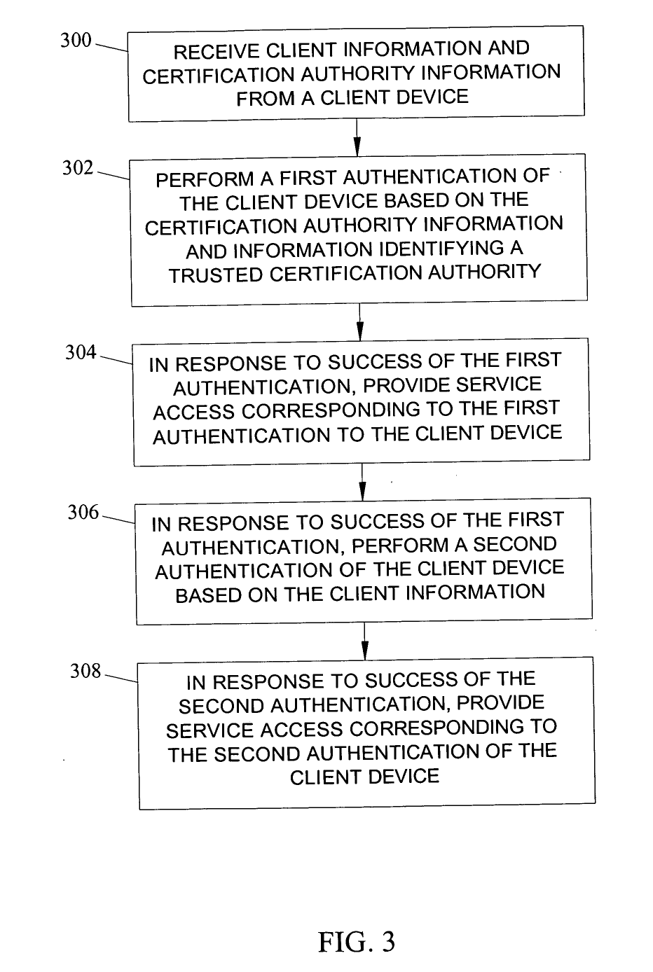

FIG. 3 is a flow chart illustrating an exemplary process for providing a client device temporary access to a service during authentication of the client device according to an embodiment of the subject matter described herein. Referring to FIG. 3, block 300 includes receiving client information and certification authority information from a client device. In block 302, a first authentication of the client device is performed based on the certification authority information and information identifying a trusted certification authority. Service access corresponding to the first authentication is provided to the client device in response to success of the first authentication (block 304). Further, in response to success of the first authentication, a second authentication of the client device is performed based on the client information (block 306). In response to success of the second authentication, service access corresponding to the second authentication of the client device is provided (block 308).

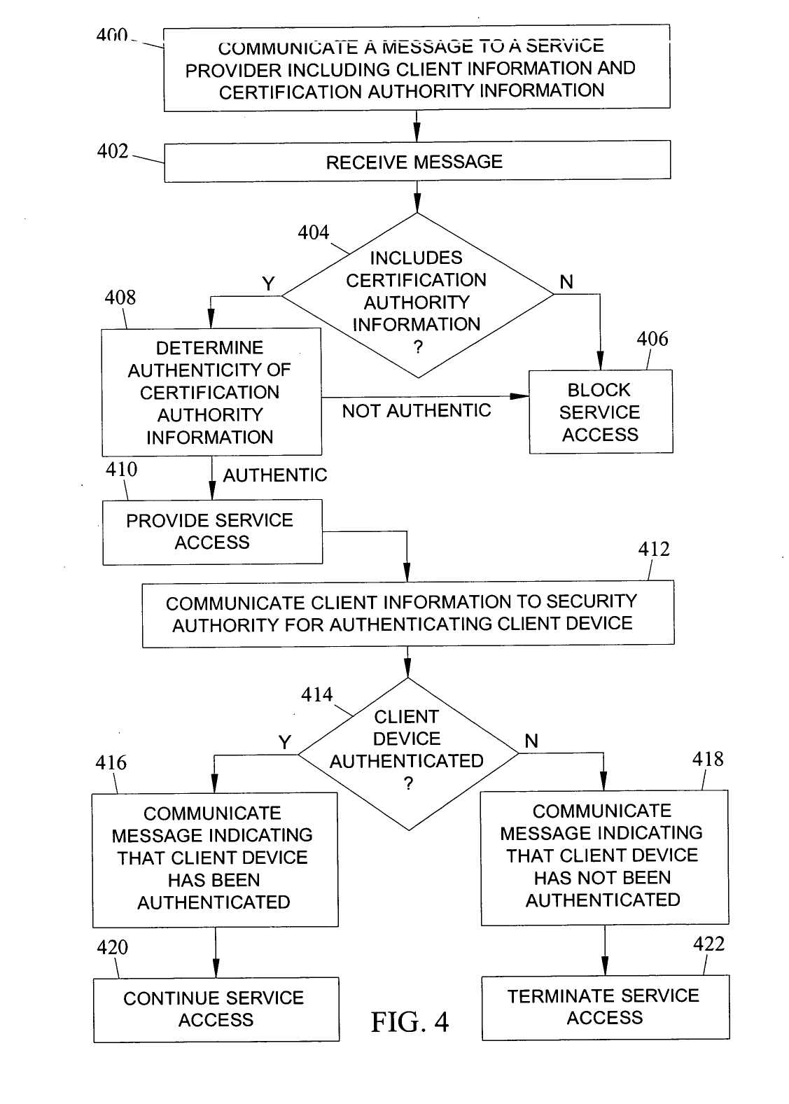

FIG. 4 is a flow chart illustrating an exemplary process for providing client device 108 shown in FIG. 1 temporary access to a service during authentication of the client device according to an embodiment of the subject matter described herein. Client device 108 may be moving between the service areas of WAPs 104 or initiating communication with one WAP 104. Referring to FIG. 4, client device 108 may communicate a message to a service provider including client information and certification authority information (block 400). Device 108 may communicate the message to a WAP or any other service access point that is servicing the area in which device 108 is located. The client information included in the message may be any suitable information that identifies client device 108 as being a subscriber to services provided by a service provider. The message sent by device 108 may or may not include certification authority information.

The certification authority information communicated by device 108 may identify one or more certificate authorities. For example, the certification authority information may include one or more digital signatures. In one embodiment, a digital signature may be a character sequence calculated using a mathematical formula. The formula may receive as inputs the sequence of characters representing the data to be signed and a secret number referred to as a signature private key. The signing party may be the only entity having access to the signature private key. The resulting computed value, representing the digital signature, may be attached to the message requesting service access. The digital signature may be uniquely associated with signed data, because the first input may be the precise sequence of characters representing that data. Further, the signature may be uniquely associated with the signing authority, because the second input is the private key that only that signing authority controls.

A public key matching the private key may be provided to the service provider for allowing signature verification. The public key may be distributed to WAPs 104 for providing service access to client devices 108 that provide a corresponding private key. The public key may be provided to WAP 104 by attaching it to a message sent by device 108.

In block 402, the message sent by client device 108 may be received by one of WAPs 104 providing coverage to the area in which device 108 is located. WAP 104 may determine whether the message includes certification authority information (block 404). If the message does not include certification authority information, service access to device 108 may be terminated or delayed until device 108 is authenticated using client information (block 406).

If it is determined that the message includes certification authority information in block 408, WAP 104 may determine the authenticity of the certification authority information in the received message (block 408). For example, WAP 104 may verify the authenticity of a digital signature attached to the message by use of a formula. The formula may receive as inputs the sequence of characters representing the supposedly signed data, the public key of the signing authority, and the value representing the supposedly authentic signature. The formula may indicate whether the signature is authentic and associated with the authority linked to the public key used in the formula. Conversely, the formula may indicate whether the signature is not authentic.

If it is determined that the certification authority information is not authentic in block 404, WAP 104 may terminate service access to client device 108 or delay service access until device 108 is authenticated using client information (block 406). Otherwise, if it is determined that the certification authority information is authentic in block 408, WAP 104 may provide service access to client device 108 (block 410). Exemplary services include voice communications service, e-mail service, and web browsing service. The certification authority information may provide client device 108 with access to one or more services from one or more different service providers. Further, for example, the message may include more than one signature for identifying more than one service provider. Client device 108 may be provided temporary access to the several different services provided by multiple service providers based on the signatures identifying the multiple service providers. In this example, the authenticity of each signature may be determined.

In block 412, WAP 104 may communicate the client information in the received message to a security authority for authenticating the client device. For example, the client information may be communicated to local security authority server 116 or global security authority server 118 for authentication of client device 108. Servers 116 and 118 may be located remotely from WAP 104. As stated previously, the client information may identify one or more client devices or subscribers. Server 116 or server 118 may search database 120 for an entry corresponding to the client information provided by WAP 104 and to authenticate client device 108 using the information. If the authentication is successful, the server that authenticated the client device may communicate a message to the WAP servicing the client device for indicating that the client device has been authenticated (block 416). If matching client information is not found in database 120 or authentication is otherwise unsuccessful, the server may transmit a message to WAP 104 indicating that the client device has not been authenticated (block 418).

Service access provided to client device 108 may be maintained based on whether the client device is authenticated. In block 420, if client device 108 is authenticated, device 108 is provided with continued service access by the service provider. In block 422, if client device 108 is not authenticated, the service access provided to device 108 may be terminated. Alternatively, as described above, the limited access granted in response to the initial authentication may be continued for a time period configurable by the network operator.

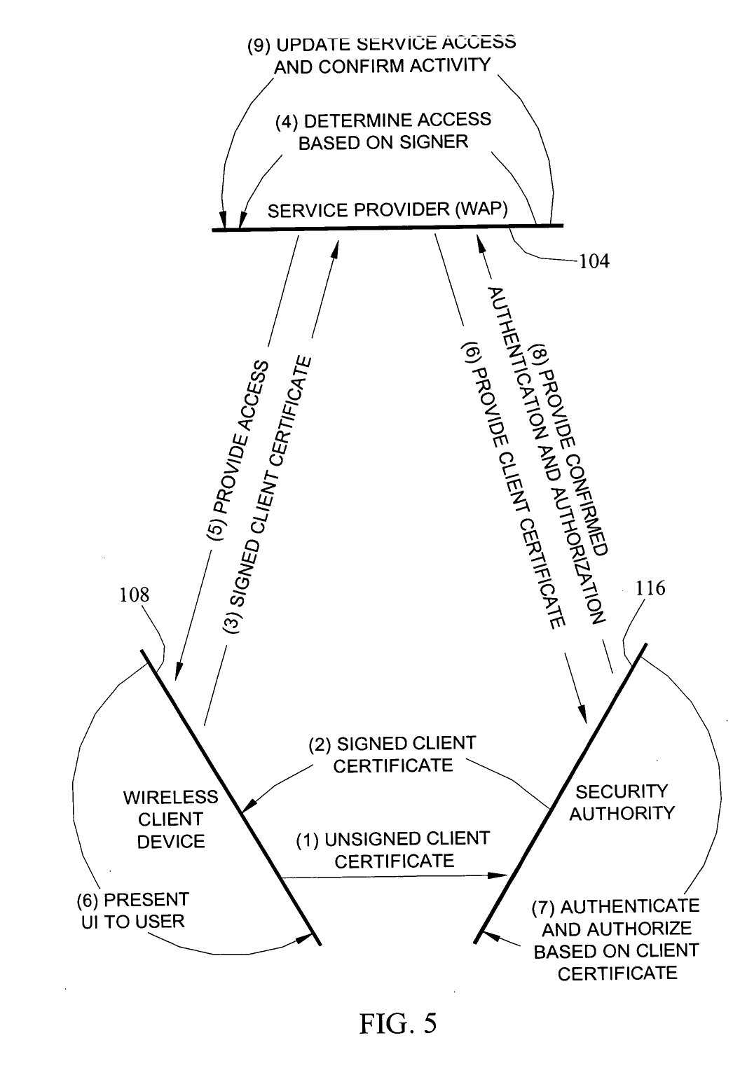

FIG. 5 is a message flow diagram of communication between WAP 104, client device 108, and security authority server 116 (or security authority 118) for providing client device 108 temporary access to a service according to an embodiment of the subject matter described herein. Initially, wireless client device 108 may communicate a certificate to security authority server 116 for signature (message 1). The certificate may include client information for identifying client device 108 and/or a subscriber associated with device 108. The security authority may determine that client device 108 is trusted, i.e., that the client device corresponds to the identification information provided, and return the signed certificate to device 108 (message 2). The security authority may not sign the certificate if it is determined that the client device is not trusted.

Client device 108 may communicate the signed certificate to WAP 104 (message 3). Based on a signer of the certificate, WAP 104 may determine whether to provide access to client device 108 (message 4). Temporary service access may be provided to WAP 104 based on the signer of the certificate (message 5). The service access may be provided during authentication and authorization of client device 108.

In message 6, WAP 104 may provide the signed client certificate to server 116 for authentication and authorization which may or may not be the security authority which signed the client's certificate. Server 116 may authenticate and authorize device 108 based on the client certificate (message 7). The client information in the certificate may be used for authenticating and authorizing device 108. In message 8, server 116 may provide a message to WAP 104 for confirming authentication and authorization for device 108. Further, if device 108 is not authenticated and authorized, server 116 may communicate a message to WAP 104 for indicating that device 108 has not been authenticated and authorized.

Upon receiving the message confirming authentication and authorization of device 108, WAP 104 may update the service access provided to device 108 and confirm the activity of device 108. Access to additional services, fewer services, or the same services may be provided to device 108. Alternatively, if device 108 was not authenticated and authorized, WAP 108 may discontinue or block the service provided to device 108. According to one embodiment, WAP 104 may include a timing function for blocking or reducing the services provided to device 108 if an authentication/authorization message is not received from server 116 (or server 118) within a predetermined time duration.

According to one embodiment, a client device may be provided with a temporary identification while temporary service access is provided to the device. The temporary identification may be used by the WAP for associating and logging provided services and billing information to the device using the temporary service. When the WAP receives an indication that the device has been authenticated and/or authorized, an actual identification may be associated with the client device and used for associating and logging provided services and billing information to the device.

Although in the examples described above, client device 108 is described as a wireless device, a client device may alternatively be a wired device (such as a desktop computer) that is connected to a network. A user may access the computer by providing credentials such as a user login identification and password. The credentials may be communicated to a security authority for signature. The user may use the signed credentials for obtaining access to the services of the network connected to the computer. A server local to the client device may receive the signed credentials and provide temporary service access to the client device based on the signature of the certificate. The temporary service access may be provided while the client device is authorized and authenticated by a remote device. The local server may communicate the credentials to the remote device for authenticating and authorizing the client device. Full service access may be provided to the client device when the local server receives notification of the authentication and authorization.

As stated above, digital signatures may be used in certificates provided by client devices 108. A digital signature can be generated by implementing a process including several steps. First, the context of the electronic transaction or document that is to be signed may be captured. Further, it should be ensured that the data displayed to the user accurately reflects the data to be digitally signed. The user may be required to signal an understanding of the commitment being made and a desire to be bound by the commitment. The user may be authenticated in order that the user's private key becomes available to the signing security authority. The signature may be computed based on the signer's private key and the data being signed. A timestamp server may append a time-date field to the data and signer's signature. The signed document may be forwarded to the client device for processing, storage, and/or subsequent verification.

In one embodiment, encryption techniques may be used together or separately with certification authority information such as signature by a certification authority. For example, a message may be encrypted but not digitally signed. In this example, only persons with a corresponding key may read the message, but the reader cannot be certain who actually wrote it. In another example, a message may be digitally signed but not encrypted. In this example, everyone may determine who wrote the message and read the message. In another example, a message may first be encrypted, and subsequently signed. In this example, only persons with the key may read message, and anyone may determine who wrote the message. In another example, a message may first be digitally signed, and the message is subsequently encrypted. In this example, only persons with the key may read the message, and only the same reader may identify who sent the message.

In one embodiment, a message sent by a client device may be digitally signed by using digital signature algorithm (DSA), the basis of the Digital Signature Standard (DSS). In this technique, a digital message sent by a client device may include a hash value. Digital signatures may depend on hash functions, which are one-way computations done on a message. These computations are typically referred to as being “one-way” because there is not a feasible way to find a message with a given hash value. In other words, a hash value may be determined for a given message, but it is not feasible to construct a message with a given hash value. Hash functions are similar to scrambling operations used with symmetric key encryption, except that there is no decryption key. Digital signatures may be used to sign the hash values of messages, not the messages themselves. Thus, it is possible to sign a message's hash value without knowing the content of the message.

It will be understood that various details of the subject matter described herein may be changed without departing from the scope of the subject matter described herein. Furthermore, the foregoing description is for the purpose of illustration only, and not for the purpose of limitation.

What is claimed is:

1. A method for providing a client device temporary access to a service during authentication of the client device, the method comprising:
receiving client information and certification authority information from a client device;
performing a first authentication of the client device based on the certification authority information and information identifying a trusted certification authority;
in response to success of the first authentication:
providing service access corresponding to the first authentication to the client device;
performing a second authentication of the client device based on the client information; and
in response to success of the second authentication, providing service access corresponding to the second authentication to the client device.

2. The method of claim 1 wherein receiving client information and certification authority information includes receiving the client information and the certification authority information in one or more encrypted messages.

3. The method of claim 1 wherein receiving client information and certification authority information includes receiving the client information and the certification authority information wirelessly.

4. The method of claim 1 wherein the certification authority information includes at least one of a digital certificate, a digital signature, and a hash value.

5. The method of claim 1 wherein the client information includes at least one of a digital certificate, a digital signature, a hash value, and a user identification and password.

6. The method of claim 1 wherein providing service access corresponding to the first authentication includes providing service access based on an authentication group associated with the certification authority information.

7. The method of claim 1 wherein performing a first authentication of the client device includes:
communicating the certification authority information to a remote authentication service; and
receiving authentication information for the client device from the remote authentication service based on the certification authority information.

8. The method of claim 1 wherein providing service access to the client device includes providing wireless service access to the client device based on the certification authority information.

9. The method of claim 1 wherein providing service access corresponding to the first authentication of the client device includes providing service access corresponding to the first authentication for a predetermined time duration.

10. The method of claim 1 wherein providing service access corresponding to the first authentication of the client device includes providing a level of service corresponding to the certification authority information.

11. The method of claim 1 wherein providing service access to the client device includes providing wireless communication service access to the client device based on the certification authority information.

12. The method of claim 1 wherein performing a second authentication of the client device includes determining whether the client information is associated with a subscription to the service provided to the client device.

13. The method of claim 1 comprising terminating service access corresponding to the first authentication in response to failure of the second authentication.

14. A method for acquiring temporary access to a service during authentication, the method comprising:
communicating client information and certification authority information to a service provider;
receiving access to a service provided by the service provider based on the certification authority information, the access being provided while the client device is authenticated using the client information; and
receiving service access based on authentication using the client information.

15. The method of claim 14 wherein communicating client information and certification authority information includes communicating the client information and the certification authority information in one or more encrypted messages.

16. The method of claim 14 wherein communicating client information and certification authority information includes wirelessly communicating the client information and the certification authority information to the service provider.

17. The method of claim 16 wherein wirelessly communicating client information and certification authority information includes wirelessly communicating the client information and the certification authority information to a wireless access point.

18. The method of claim 14 wherein the certification authority information includes at least one of a digital certificate, a digital signature, and a hash value.

19. The method of claim 14 wherein the client information includes at least one of a digital certificate, a digital signature, a hash value, and a user identification and password.

20. The method of claim 14 wherein receiving access to a service includes receiving access to the service based on the certification authority information for a predetermined time duration.

21. The method of claim 14 wherein receiving access to a service includes receiving service access based on an authentication group associated with the certification authority information.

22. The method of claim 14 wherein receiving access to a service includes receiving access to a wireless service provided by the service provider.

23. The method of claim 14 wherein receiving access to a service includes receiving access to a wireless communication service provided by the service provider.

24. The method of claim 14 wherein receiving service access based on authentication using the client information includes providing a level of service corresponding to the certification authority information.

25. The method of claim 14 wherein the steps of the method are performed at a wireless device.

26. The method of claim 25 wherein the wireless device is a device selected from the group consisting of a mobile phone, a computer, and a personal digital assistant.

27. A system for providing a client device temporary access to a service during authentication of the client device, the system comprising:
a communication module operable to receive client information and certification authority information from a client device;
an authentication function operable to:
perform a first authentication of the client device based on the certification authority information and information identifying a trusted certification authority; and
in response to success of the first authentication, provide service access corresponding to the first authentication to the client device, perform a second authentication of the client device based on the client information, and provide service access corresponding to the second authentication to the client device in response to success of the second authentication.

28. The system of claim 27 wherein the communication module is operable to receive the client information and the certification authority information in one or more encrypted messages.

29. The system of claim 27 wherein the communication module is operable to receive the client information and the certification authority information wirelessly.

30. The system of claim 27 wherein the certification authority information includes at least one of a digital certificate, a digital signature, and a hash value.

31. The system of claim 27 wherein the client information includes at least one of a digital certificate, a digital signature, a hash value, and a user identification and password.

32. The system of claim 27 wherein the authentication function is operable to provide service access to the client device based on an authentication group associated with the certification authority information.

33. The system of claim 27 wherein the communication module is operable to communicate the certification authority information to a remote authentication service and the communication module is operable to receive authentication information for the client device from the remote authentication service based on the certification authority information.

34. The system of claim 27 wherein the authentication function is operable to provide wireless service access to the client device based on the certification authority information.

35. The system of claim 27 wherein the authentication function is operable to provide service access corresponding to the first authentication for a predetermined time duration.

36. The system of claim 27 wherein the authentication function is operable to provide a level of service corresponding to the certification authority information.

37. The system of claim 27 wherein the authentication function is operable to provide wireless communication service access to the client device based on the certification authority information.

38. The system of claim 27 comprising a remote service provider server operable to determine whether the client information is associated with a subscription to the service provided to the client device.

39. The system of claim 27 wherein the authentication function is operable to terminate service access corresponding to the first authentication in response to failure of the second authentication.

40. A client device for acquiring temporary access to a service during authentication, the client device comprising:
a communication module operable to communicate client information and certification authority information to a service provider for performing first and second authentications; and
a service receiver function operable to receive service access corresponding to the first authentication in response to success of the first authentication and to receive access corresponding to the second authentication in response to success of the second authentication.

41. The client device of claim 40 wherein the communication module is operable to communicate the client information and the certification authority information in one or more encrypted messages.

42. The client device of claim 40 wherein the communication module is operable to wirelessly communicating the client information and the certification authority information to the service provider.

43. The client device of claim 42 wherein the communication module is operable to communicate the client information and the certification authority information to a wireless access point.

44. The client device of claim 40 wherein the certification authority information includes at least one of a digital certificate, a digital signature, and a hash value.

45. The client device of claim 40 wherein the client information includes at least one of a digital certificate, a digital signature, a hash value, and a user identification and password.

46. The client device of claim 40 wherein the service access corresponding to the first authentication includes network access for a predetermined time duration.

47. The client device of claim 40 wherein the service access corresponding to the first authentication includes common access provided to a group of client devices.

48. The client device of claim 40 wherein the service access corresponding to the second authentication includes an application-level service.

49. The client device of claim 40 wherein the service receiver function is operable to receive access to a wireless communication service provided by the service provider.

50. The client device of claim 40 wherein the client device is a device selected from the group consisting of a mobile phone, a computer, and a personal digital assistant.

51. A system for providing a client device temporary access to a service during authentication of the client device, the system comprising:
means for receiving client information and certification authority information from a client device;
means for performing a first authentication of the client device based on the certification authority information and information identifying a trusted certification authority;
means for providing service access corresponding to the first authentication to the client device in response to success of the first authentication;
means for performing a second authentication of the client device based on the client information in response to success of the first authentication; and
means for providing service access corresponding to the second authentication to the client device in response to success of the second authentication.

52. A system for acquiring temporary access to a service during authentication, the system comprising:
means for communicating client information and certification authority information to a service provider;
means for receiving access to a service provided by the service provider based on the certification authority information, the access being provided while the client device is authenticated using the client information; and
means for receiving service access based on authentication using the client information.

53. A computer program product comprising computer executable instructions embodied in a computer readable medium for performing steps comprising:
receiving client information and certification authority information from a client device;
performing a first authentication of the client device based on the certification authority information and information identifying a trusted certification authority;
in response to success of the first authentication:
providing service access corresponding to the first authentication to the client device;
performing a second authentication of the client device based on the client information; and
in response to success of the second authentication, providing service access corresponding to the second authentication to the client device.

54. A computer program product comprising computer executable instructions embodied in a computer readable medium for performing steps comprising:
communicating client information and certification authority information to a service provider;
receiving access to a service provided by the service provider based on the certification authority information, the access being provided while the client device is authenticated using the client information; and
receiving service access based on authentication using the client information.
